(19) United States
(12) Patent Application Publication
(10) Pub. No.: US 2008/0203757 A1
(43) Pub. Date: Aug. 28, 2008

(54) Stroller cover

(75) Inventor: Victoria Gilberg, Ashdod (IL)

Correspondence Address: Martin D. Moyniham;PRTSI, Inc., P.O. Box 16446, Arlington, VA, 22215, US

(73) Assignee: Vilengy Ltd., Ashdod (IL)

(21) Appl. No.: 12/149,079

(22) Filed: Apr. 25, 2008

Related U.S. Application Data
(63) Continuation of application No. PCT/IL2006/001216, filed on Oct. 23, 2006.

(30) Foreign Application Priority Data
Oct. 26, 2005 (IL) 171562

(51) Int. Cl. B62B 9/12

(52) U.S. Cl. 296/100.16

(57) ABSTRACT

A baby stroller cover includes a cover material and a plurality of stroller attachment elements, at least some of which are clothespin type fasteners each including a pair of arms pivotally mounted to each other at a mid-portion such that one of their ends serves as clamping elements which are spring-urged to a closed position, and their other ends serve as finger-pieces which are squeezable towards each other to move the clamping elements to an open position. An arm of each of the clothespin type fasteners is attached to an edge of the cover material to permit quick attachment of the cover material to the baby stroller, and also attachment of a toy or ornamental device from an arm of the clothespin type fastener when the cover material is attached to the baby stroller.

### RELATED APPLICATIONS

This application is a Continuation of PCT Patent Application No. PCT/IL2006/001216 filed Oct. 23, 2006, which claims the benefit of Israel Patent Application No. 171562 filed Oct. 26, 2005. The contents of the above Applications are all incorporated herein by reference.

### FIELD AND BACKGROUND OF THE INVENTION

The present invention relates to a stroller cover and, more particularly, to an adjustable and modular stroller cover which can be used in a variety of strollers.

Many conventional baby transport devices such as baby strollers include integral canopies which are configured to protect a child occupant from the harmful effects of sunlight (e.g. UV radiation) as well as any discomfort which can be caused by intense sunlight. While these canopies may protect the child from vertical sunlight, they are ineffective in providing protection from lateral and reflected sun rays.

Numerous add-on sun shades and stroller covers are known in the art. Stroller covers can be typically categorized as frame-supported covers and self-supporting covers.

Frame-supported covers are cumbersome to install, awkward to store, and do not allow quick and immediate access to the child occupant should the need arise. Another problem with the frame-supported covers is that the child occupant is completely enclosed in a visually limiting cover which can lead to feelings of discomfort or fear which in turn can lead to a fretful, crying baby or child. Moreover, the cover may also limit fresh air from passing through the stroller, so that the air under the cover is hot and stale, further adding to the baby's discomfort.

Self-supporting covers are typically formed from a foldable material such as cardboard, plastic, and the like. The material is cut and scored to provide a preselected pattern which when folded into its fully assembled configuration, enables attachment to a stroller for blocking sunlight. Self-supporting covers are typically configured to be installed above the stroller such that they allow quick and immediate access to the child occupant should the need arise. Unfortunately, self-supporting covers generally do not provide ample protection against lateral and reflected sun rays.

One known type of self-supporting baby stroller cover is described in U.S. Pat. No. 7,052,085. The stroller cover described in that patent utilizes hook-and-loop (e.g. Velcro™) fastener elements for securing the cover material to the stroller. However, it is frequently desirable to suspend various types of toys or ornaments above the baby's head to catch the baby's interest or to enable the baby to interact with such toys or ornaments. The construction described in this patent, using hook-and-loop fastener elements does not conveniently permit the suspension of toys and/or ornaments for this purpose.

An object of the present invention is to provide a stroller cover having advantages in one or more of the above respects. Another object is to provide a novel clothespin type fastener particularly used in the novel baby cover.

### SUMMARY OF THE INVENTION

According to a broad aspect of the present invention, there is provided a baby stroller cover comprising: a cover material and a plurality of stroller attachment elements each being attached to the cover material for removably attaching the cover material to the baby stroller: characterized in that at least some of the stroller attachment elements are clothespin type fasteners each including a pair of arms pivotally mounted to each other at a mid-portion thereof such that one of their ends serves as clamping elements which are spring-urged to a closed position, and their other ends serve as finger-pieces which are squeezable towards each other to move the clamping elements to an open position; and further characterized in that an arm of each of the clothespin type fasteners is attached to an edge of the cover material to permit quick attachment of the cover material to the baby stroller, and also quick attachment of a toy or ornamental device from an arm of the clothespin type fastener when the cover material is attached to the baby stroller.

According to further features in the described preferred embodiments, the latter arm of each clothespin type fastener is formed with a loop or hook for suspending the toy or ornamental device therefrom when the cover material is attached to the baby stroller. In addition, the arm of each of the clothespin-type elements attached to the edge of the cover material is removably attached thereto by a fastener having one fastener element carried by the arm, and a second fastener element carried by the cover material.

Several preferred embodiments of the invention are described for purposes of example. In some embodiments, the fastener elements for removably attaching each of the clothespin type fasteners are snap-type fastener elements, whereas in other embodiments, they are hook-and-loop fastener elements.

In addition, in some described embodiments, the edge of the cover material to which the arm of each of the clothespin type fasteners is attached is formed with a pocket for receiving the end of the arm attached thereto by the fastener elements; whereas in other described embodiments, the latter edge carries a snap-fastener element to receive a mating snap-fastener element carried at the end of the arm.

According to further features in some described embodiments, the baby stroller cover includes a plurality of the clothespin-type fasteners for removably attaching one edge of the cover material to the baby stroller, and a plurality of the stroller attachment elements for removably attaching an opposite edge of the cover material to the baby stroller. In some described preferred embodiments, the plurality of stroller attachment elements include hook-and-loop fasteners; in other described embodiments, they include snap-type fasteners; and in a further described embodiment, they include stretchable straps. The plurality of stroller attachment elements may be constructed so as to be variable in length.

According to further features in the described preferred embodiments, the cover material further includes a plurality of mateable fastener elements located between the opposed edges of the cover material permit the length of the cover material to be varied. In the described preferred embodiments, the mateable fastener elements are snap-type fastener elements.

According to still further features in the described preferred embodiments, the cover material is dimensioned such that, when applied to the baby stroller, a space is provided on the opposite sides of the cover material to permit air and light to enter the baby stroller and also to permit viewing of, and access to, the baby in the stroller. The cover material may also include a window aligned with the head of a baby in the baby stroller, when the cover is attached to the stroller, to permit both viewing the baby, and viewing by the baby.

According to another aspect of the present invention, there is provided a clothespin-type fastener for fastening a first member to a second member, comprising: a pair of arms pivotally mounted to each other at a mid-portion thereof, such that one of their ends serve as clamping elements which are spring-urged to a closed position to clamp onto the one member, and their other ends serve as finger-pieces which are squeezable towards each other, to move the clamping elements to an open position to release the one member; characterized in that one of the arms includes at least one fastener element mateable with another fastener element carried by the second member for releasably attaching the clothes-type fastener to the second member.

The present invention thus successfully addresses the shortcomings of the presently known configurations by providing a modular stroller cover which can be fitted to a variety of stroller types, provides easy access to a child occupant, protects the child from the harmful effects of the environment, and conveniently enables toys or ornamental devices to be suspended within the reach or the view of the baby.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1a and 1b illustrate the bottom (FIG. 1a) and top (FIG. 1b) sides of a stroller cover constructed in accordance with the present invention.

FIGS. 2-4 illustrate various attachment elements which can be utilized in the present invention for attaching one edge of the stroller cover to the stroller.

FIGS. 5-9 illustrate various constructions of clothespin type attachment elements which can be used for attaching the opposite edge of the cover to the stroller;

FIG. 10 illustrates the attachment of the stroller cover to a canopy and handle of a stroller.

FIGS. 11-13 illustrate stroller cover which provide various child visibility, FIG. 11 illustrating a completely opaque cover embodiment in which the child is not visible through the stroller cover, while of FIGS. 12 and 13 illustrate covers providing various degrees of visibility;

FIGS. 14 and 15 illustrate a stroller cover of adjustable length in non-folded (FIG. 14) and folded (FIG. 15) states, respectively;

FIG. 16 illustrates a stroller cover having a top flap designed for covering the stroller attachment elements;

FIGS. 17-21 illustrate various covering options provided by the stroller cover of the present invention;

FIGS. 22-24 illustrate various types of ornaments and toys that may be attached to the stroller cover of the present invention.

### DESCRIPTION OF THE PREFERRED EMBODIMENTS

The present invention is of a baby stroller cover which can be used to cover various portions of the baby compartment of a baby stroller, or of similar types of baby transportation devices.

The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Numerous stroller cover configurations are known in the art; see for example U.S. Pat. No. 5,542,732 or published U.S. Pat. Applications 2004244301 and 2003193221 corresponding to the above-cited U.S. Pat. No. 7,052,085.

Although such prior art configurations are capable of providing ample shading or access to a baby occupant of the stroller they are typically incapable of using the cover attachment elements for attaching toys or ornamental devices for viewing by, or interacting with, the baby occupant.

While reducing the present invention to practice the present inventors have devised a stroller cover which provides excellent protection from the harmful effects of the environment (sun, wind, rain, snow, insects and the like) while enabling quick and easy access to the baby occupant and convenient mounting of toys or ornamental devices for viewing of, or interaction by, the baby occupant. An additional advantage of the present stroller cover comes from its modular construction which allows easy detachment of the stroller attachment elements from the cover material thus facilitating laundering of the cover material.

As used herein, the phrase “baby stroller” refers to any baby transport device including baby carriages, baby joggers and the like.

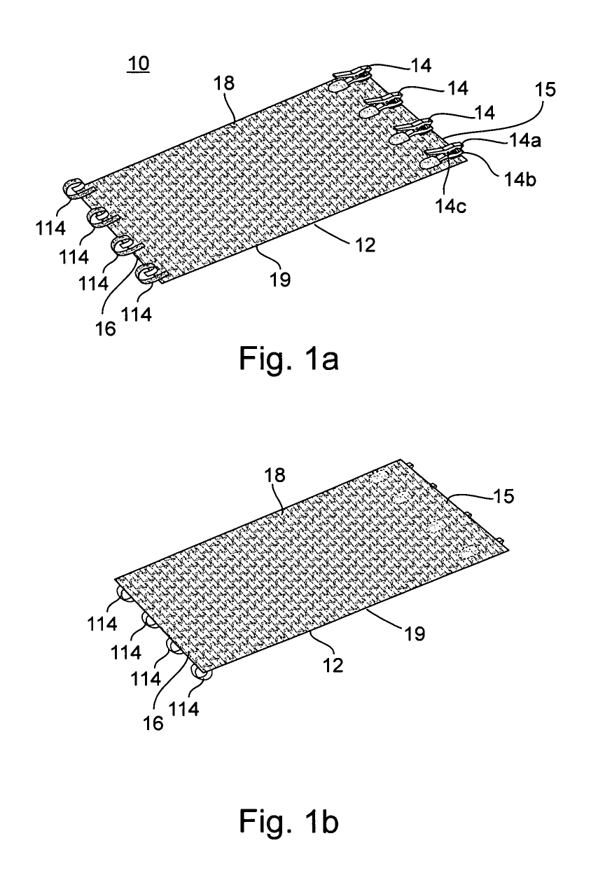

The baby stroller cover illustrated in the drawings is generally referred to herein as cover 10. As shown in FIGS. 1a-B, cover 10 includes a cover material 12 and a plurality of stroller attachment elements 14. Stroller attachment elements 14 can be attached along a width 15 of cover material 12 and/or along a length 18 of cover material 12.

FIGS. 1a and 1b illustrate the cover material 12 attachable to the stroller along its length by a first plurality of stroller attachment elements 14 along one transverse edge 15 of the cover material, and by a second plurality of stroller attachment elements 114 along the opposed transverse edge 16, leaving the two opposed longitudinal edges 18 and 19 free.

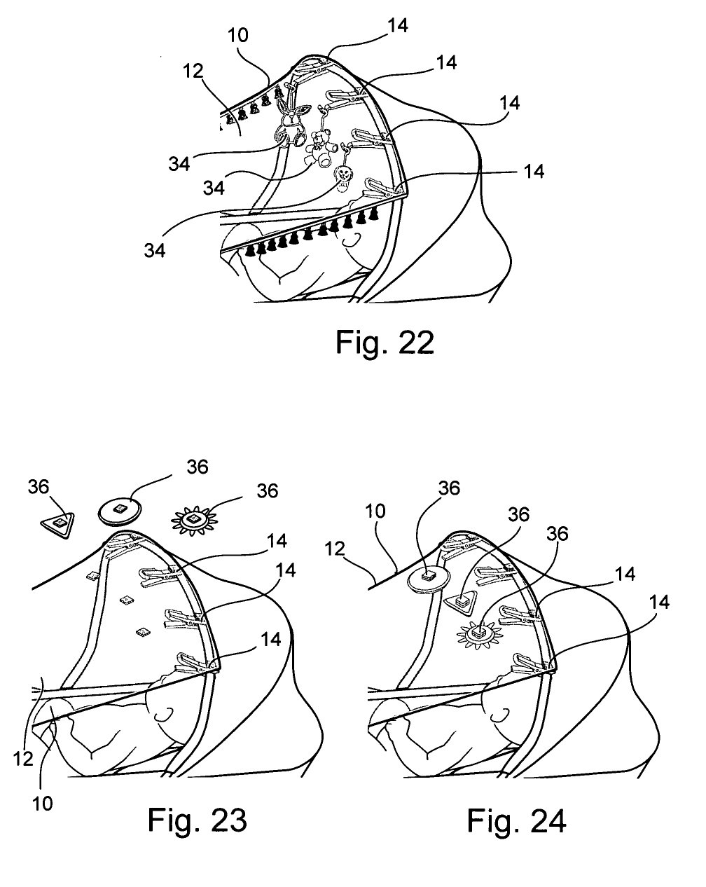

As also seen particularly in FIG. 1a, the stroller attachment elements 14 along edge 15 are clothespin type fasteners. As well known, such fasteners include a pair of arms 14a, 14b, pivotally mounted to each other at a mid portion 14c, such that one of their ends (right ends, FIGS. 1a and 6) serve as clamping elements which are spring-urged to a closed position, and their other ends (left ends, FIGS. 1a and 6) serve as finger-pieces which are squeezable towards each other to move the clamping elements to an open position. As will be further described below particularly with reference to FIGS. 22-24 of the clothespin type fasteners 14 not only permit quick attachment of the cover material to the baby stroller, but also an arm of each fastener 14 permits convenient attachment of a toy or ornamental device for viewing by the baby or for interaction with the baby.

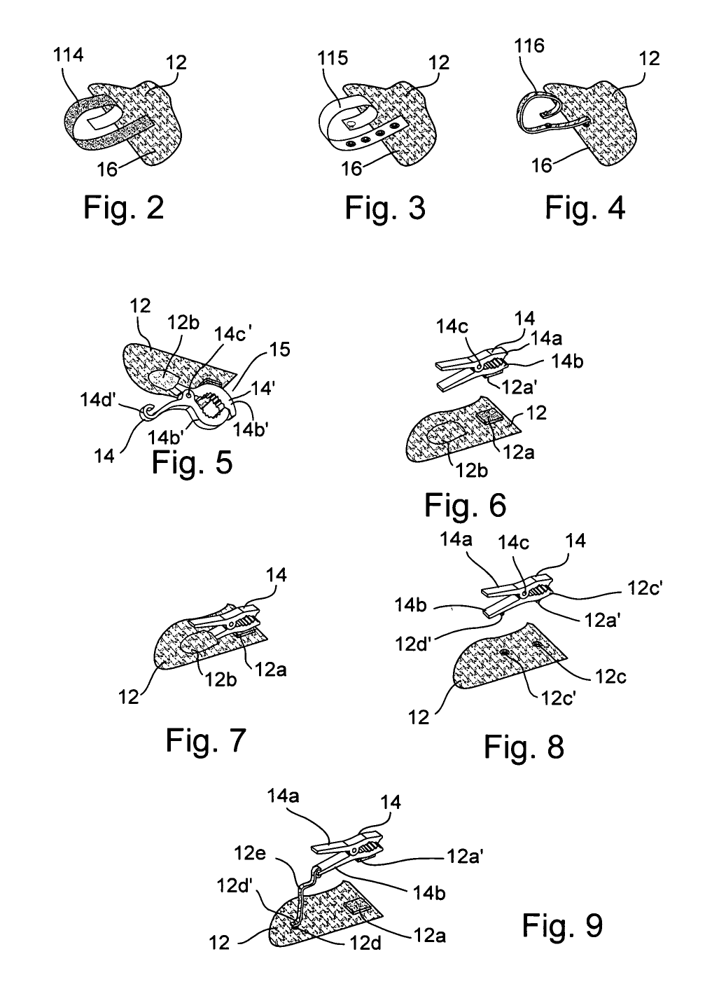

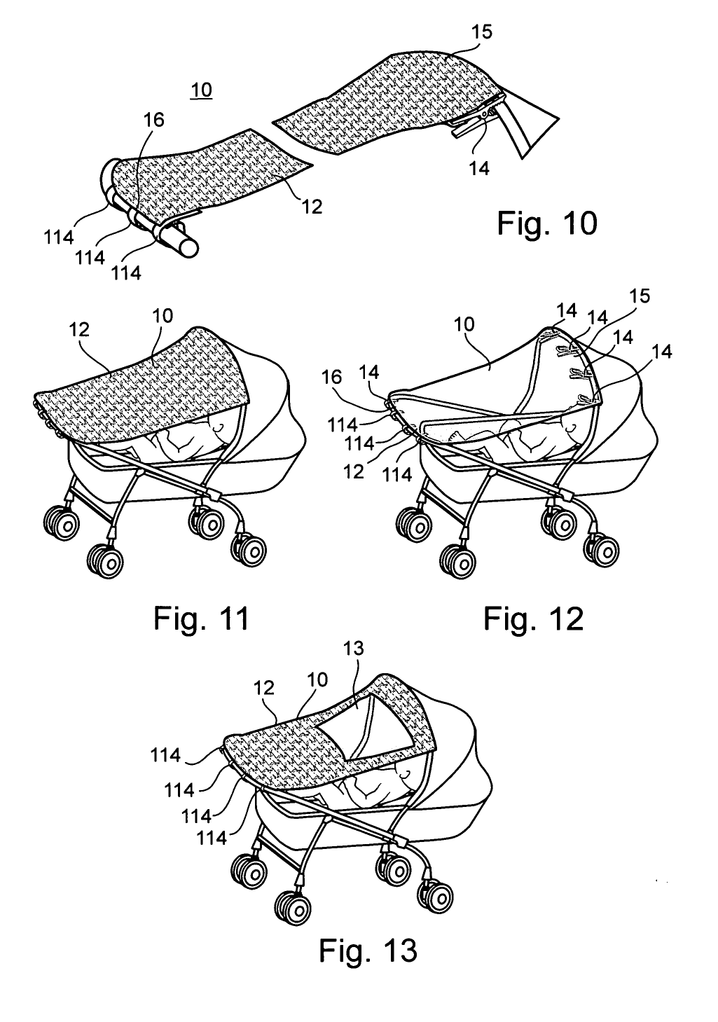

Numerous types of stroller attachment elements 114 can be utilized for attaching the opposite edge 16 of cover 10. FIGS. 2-4 illustrate several such types. Thus, loops can be used made from an adjustable hook-and-loop (e.g. “Velcro”) type strap (FIG. 2), a snap-type adjustable strap 115 (FIG. 3), or a stretchable strap 116 (e.g. rubber) having a snap-type connector (FIG. 4).

FIG. 5 illustrates another type of clothespin fastener, therein designated 14′, that may be applied to edge 15 of the cover material 12. Clothespin fastener 14′ of FIG. 5 also includes a pair of arms 14a′, 14b′, pivotally mounted to each other at a mid portion 14c′. Arm 14b′ is fixed to the cover material 12 along edge 15, and the other arm 14a′ is formed, at its finger-piece end on one side of its pivotal mounting 14c′, with a loop or hook 14d′ to serve for suspending a toy or ornamental device, as shown for example in FIG. 22.

The type and positioning of stroller attachment elements 14 and 114 depend largely on the intended positioning of cover 10 on the stroller and the type of stroller used. For example, if cover 10 is to be positioned between a handle and canopy of a stroller (as shown in FIGS. 11-13), then clothespins 14 are preferably used at the canopy side of cover 10, while loops 114 (Velcro™ or snap-type) are preferably used at the handle side of cover 10.

Stroller attachment elements 14 and 114 can be permanently attached to cover material 12, but preferably they are detachably attached. The latter configuration enables a user of cover 10 to change the stroller attachment elements 14 as and when desired, as well as to change their positions of attachment to cover material 12. They also enable convenient removal of the attachment elements, e.g. for washing the cover material, transporting them or storing them.

Several approaches can be used to provide removably attached stroller attachment elements 14 and 114. FIGS. 5-9 exemplify several attachment configurations suitable for detachably attaching a clothespin-type stroller attachment element 14 or 14′ (FIG. 5). Preferably, one of its pivotal arms (e.g., 14b) is attached to the cover material 12 preferably at two attachment points co-operable with the two opposite ends of the arm.

FIGS. 5-7 illustrate one attachment point effected by hook-and-loop fastener elements, (e.g. “Velcro”™). One fastener element e.g. 12a (FIG. 6) is carried by the cover material 12, and the other fastener element 12a′ is carried at one end of arm 14b of fastener 14. The second attachment point may be in the form of a pouch 12b formed in cover material 12 adapted to receive the opposite end of arm 14b of fastener 14, as shown in FIGS. 5, 6 and 7.

FIG. 8 illustrates a variation wherein the two attachment points are effected by snap-type fasteners, one element of each of the two attachment points being carried by the cover material 12, as shown at 12c and 12d, and the other fastener element being carried by arm 14b of fastener 14, as shown at 12c′ and 12d′.

FIG. 9 illustrates a further variation wherein one attachment point is effected by hook-and-loop elements 12a, 12a′ and the other attachment point is effected by a stretchable strap 12e fixed at one end to the arm 14b of attachment element 14, and the opposite end having a snap-type fastener element 12d′ receivable in a snap-type fastener element 12d carried by the cover material 12.

Cover material 12 may be any type of material which can be used to protect a baby occupant of the stroller from sunshine, rain, snow, wind, etc., while providing ample air circulation and, optionally, child visibility. Examples of materials suitable for use as cover material 12 include cotton, viscose, polypropylene, polyester, mesh and any mixes thereof.

Cover material 12 can be opaque, transparent or semi transparent. Transparent or semi-transparent configurations of cover material 12 can be fabricated from a transparent or semitransparent polymer (e.g. polyurethane, polypropylene) or from a mesh such as cotton, polypropylene, etc.

Cover material 12 can be fabricated from a single material or any combination of materials depending on the intended purpose and use. For example, sunlight/UV shade can be fabricated from mesh material alone (FIG. 12). When used as a wind protectant, cover material 12 can be fabricated from a combination of wind blocking material (e.g. nylon) and transparent or semitransparent material such as polyurethane which can serve as a window 13 for internal viewing of the baby occupant or for external viewing by the baby occupant (FIG. 13).

Device 10 can also include a flap 17 attached to one or more ends of cover material 12. As is shown in FIG. 16, such a flap can be used to aesthetically cover and to optionally seal any gaps between stroller and cover material 12 caused by stroller attachment elements 14.

Cover material 12 can be provided in numerous shapes and sizes including rectangles, squares, triangular, oval and the like. Preferably, cover material 12 is provided as a rectangle having a length adjustable from about 70 cm to about 110 cm and a width adjustable from about 50 cm to about 70 cm, which would be suitable for most strollers on the market today.

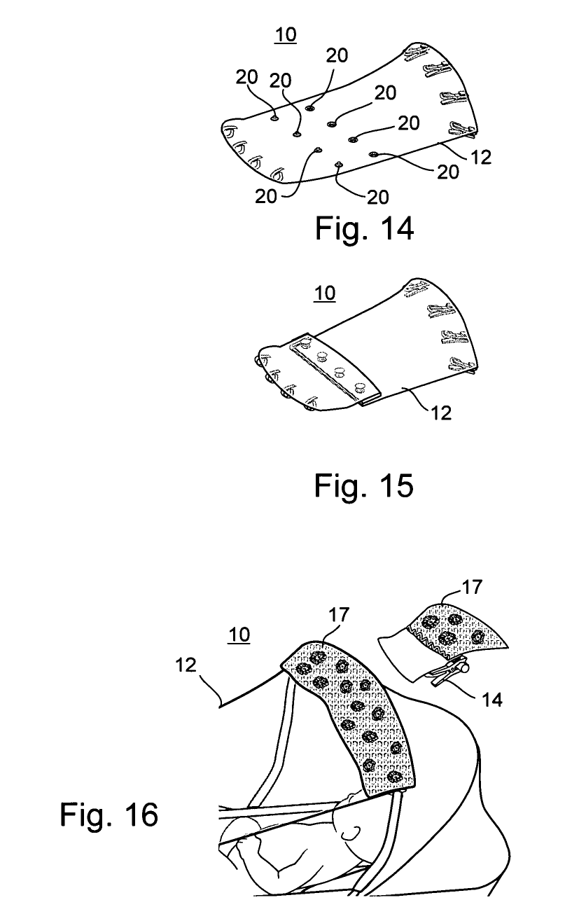

Several approaches can be used to make cover material 12 adjustable in length and/or width. Preferably, length and/or width adjustment is effected via folding or rolling of cover material 12. FIGS. 14 and 15 illustrate one such foldable configuration, which enables adjustment of the length of cover material 12. The exemplified configuration includes a plurality of mateable snap fasteners 20 which, when interconnected, fold to shorten the length of cover material 12 (FIG. 15).

It will be appreciated that such a length adjustment configuration allows use of device 10 in various stroller sizes and across various stroller portions. Such an adjustment approach is advantageous over prior art stretchable covers in which length (or width) is adjusted by the amount of stretching force applied to the cover material. Stretchable covers are subjected to continuous stretching forces and ultimately lose their elasticity and ability to properly cover the child occupant, whereas the adjustment approach utilized in cover material 12 of device 10 does not subject cover material 12 to forces which can result in excessive wear and tear of the cover.

Since cover 10 of the present invention is positioned in a field of view of a baby occupant of the stroller, it can also serve as a point of attachment for a variety of ornamental and/or functional playthings (e.g. toys) which the baby can interact with. FIG. 22 illustrate cover 10 with toys 34 attached from stroller attachment elements 14, via for example the clothespin configuration of FIG. 5, while FIGS. 23-24 illustrate ornamental devices 36 which are fastened to an inside surface of cover material 12 via, for example, Velcro fasteners or snap fasteners.

Since cover 10 of the present invention is both modular (enabling use of several types of stroller attachment elements) and adjustable it can be used in a variety of stroller types (four wheel, three wheel, joggers etc) and attachment configurations.

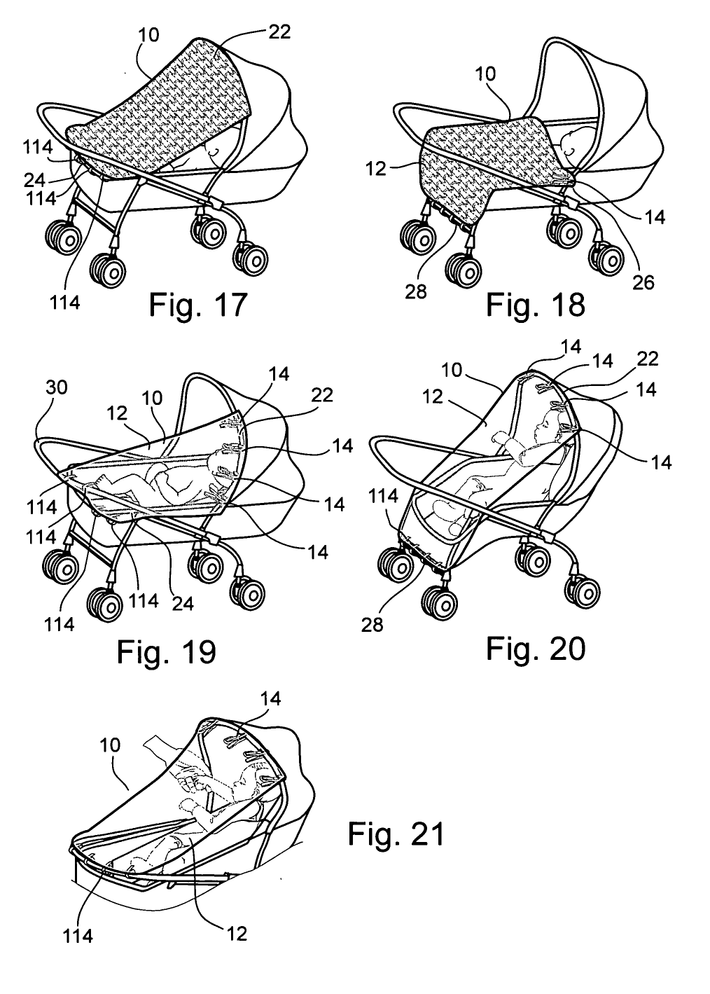

FIGS. 17-21 illustrate several stroller attachment configurations including canopy arch support 22 to basinet rear end 24 (FIG. 17), frame 26 at mid-basinet to frame 28 (FIG. 18), canopy arch support 22 to handle 30 and basinet rear end 24 (FIG. 19), canopy arch support 22 to frame 28 (FIG. 20) and canopy arch support 22 to handle 30 (FIG. 21).

It will be appreciated that the above described attachment configurations can be used to fully or preferably partially cover the baby compartment (the latter being illustrated by FIG. 17-21). Partial covering provides several benefits including airflow and access to the child, the latter being exemplified by FIG. 21.

Cover 10 of the present invention can be provided as a stroller dedicated configuration or as a kit which can be used in a variety of stroller types and sizes. Such a kit can include one or more cover materials 12 of varying sizes and/or material types and various types of stroller attachment elements 14 and 114. The kit can further include instructions for selecting appropriate stroller attachment elements to be used as well as preferred points of attachments for various attachment configurations.

The kit can also include toys and ornaments to be hung inside cover material 12 as well as hanging hooks.

As used herein the term “about” refers to ±10%

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A baby stroller cover comprising a cover material and a plurality of stroller attachment elements each being attached to said cover material for removably attaching said cover material to the baby stroller:
characterized in that at least some of said stroller attachment elements are clothespin type fasteners each including a pair of arms pivotally mounted to each other at a mid-portion thereof such that one of their ends serve as clamping elements which are spring-urged to a closed position, and their other ends serve as finger-pieces which are squeezable towards each other to move said clamping elements to an open position;
and further characterized in that an arm of each of said clothespin type fasteners is attached to an edge of the cover material to permit quick attachment of the cover material to the baby stroller, and also quick attachment of a toy or ornamental device from an arm of the clothespin type fastener when the cover material is attached to said baby stroller.

2. The baby stroller cover according to claim 1, wherein said latter arm of said clothespin type fastener is formed with a loop or hook for suspending a toy or ornamental device therefrom when the cover material is attached to said baby stroller.

3. The baby stroller cover according to claim 1, wherein said arm of each of said clothespin type fasteners attached to said edge of the cover material is removably attached thereto by a fastener having one fastener element carried by said arm, and a second fastener element carried by said cover material.

4. The baby stroller cover according to claim 3, wherein said fastener elements for removably attaching each of said clothespin type fasteners are snap-type fastener elements.

5. The baby stroller cover according to claim 3, wherein said fastener elements for removably attaching each of said clothespin type fasteners are hook-and-loop fastener elements.

6. The baby stroller cover according to claim 3, wherein the edge of the cover material to which said arm of each of said clothespin type fasteners is attached is formed with a pocket for receiving the end of the arm attached thereto by said fastener elements.

7. The baby stroller cover according to claim 3, wherein the edge of the cover material to which the arm of each of said of clothespin-type fasteners is attached carries a snap-fastener element to receive a mating snap-fastener element carried at the end of said arm.

8. The baby stroller cover according to claim 1, wherein said baby stroller cover includes a plurality of the clothespin-type fasteners for removably attaching one edge of the cover material to the baby stroller, and a plurality of stroller attachment elements for removably attaching an opposite edge of the cover material to the baby stroller.

9. The baby stroller cover according to claim 8, wherein said plurality of stroller attachment elements include hook-and-loop fasteners.

10. The baby stroller cover according to claim 8, wherein said plurality of stroller attachment elements include snap-type fasteners.

11. The baby stroller cover according to claim 8, wherein said plurality of stroller attachment elements include stretchable straps.

12. The baby stroller cover according to claim 8, wherein said plurality of stroller attachment elements are constructed so as to be variable in length.

13. The baby stroller cover according to claim 1, wherein said cover material further includes a plurality of mateable fastener elements located between opposite edges of the cover material permitting the length of the cover material to be varied.

14. The baby stroller cover according to claim 13, wherein said mateable fastening elements are snap-type fastener elements.

15. The baby stroller cover according to claim 1, wherein said cover material is dimensioned such that, when applied to the baby stroller, a space is provided on the opposite sides of the cover material to permit air and light to enter the baby stroller and to permit viewing of, and access to, the baby in the stroller.

16. The baby stroller cover according to claim 1, wherein said cover material includes a window aligned with the head of a baby in the baby stroller, when the cover is attached to the stroller, to permit viewing the baby, and viewing by the baby.

17. A clothespin-type fastener for fastening a first member to a second member, comprising:
a pair of arms pivotally mounted to each other at a mid-portion thereof, such that one of their ends serve as clamping elements which are spring-urged to a closed position to clamp onto said one member, and their other ends serve as finger-pieces which are squeezable towards each other, to move said clamping elements to an open position to release said one member;
characterized in that one of said arms includes at least one fastener element mateable with another fastener element carried by said second member for releasably attaching said clothespin-type fastener to said second member.

18. The fastener according to claim 17, wherein said fastener element included in one of said arms is located on one side of the pivotal mid-portion of the arm, and wherein said one arm includes a second fastener element located on the opposite side of the pivotal mid-portion and mateable with a second fastener element carried by said second member.

19. The fastener according to claim 17, wherein said fastener element included in one of said arms is one element of a snap-type fastener mateable with a second element of the snap-type fastener carried by said second member.

20. The fastener according to claim 17, wherein said connector element carried by said one arm is one element of a hook-and-loop fastener mateable with a second element of the hook-and-loop fastener carried by said second member.
